(19) United States
(12) Patent Application Publication
(10) Pub. No.: US 2008/0060709 A1
(43) Pub. Date: Mar. 13, 2008

(54) ADJUSTABLE WATER-DISPERSING DEVICE FOR A FAUCET

(76) Inventor: Ming-Dang Shieh, Changhua (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/531,623

(22) Filed: Sep. 13, 2006

(51) Int. Cl. F16K 21/00

(52) U.S. Cl. 137/801

(57) ABSTRACT

An adjustable water-dispersing device has a housing, a valve shaft, a plug, a resilient element, a pivotal bracket, a handle and a mouth cap. Wherein, the housing has a channel, a valve chamber and a water chamber communicated with each other in sequence. Two draining holes extend between the valve chamber and the water chamber. The valve shaft is movably received inside the valve chamber and pushed by the resilient element between the valve shaft and the plug. The pivotal bracket is attached on an outer periphery of the housing to make the handle pivotally mounted on both the pivotal bracket and the valve shaft to drive the valve shaft. The mouth cap received inside the water chamber combines with an aerator at its center and has multiple spraying holes. Thereby, the handle enables to move the valve shaft to easily switch the spouting types.

### BACKGROUND OF THE INVENTION

1. Field of the Invention

The present invention relates to an adjustable water-dispersing device, and more particularly to an adjustable water-dispersing device mounted on a faucet to conveniently switch between a narrow spouting status and a wide spouting status.

2. Description of Related Art

A conventional faucet as shown in FIG. 1, a spout 101 is formed at a front end of a faucet 10 and drains water directly therefrom when the faucet 10 opens. Without any auxiliary, the water spouts substantially in pillar shape that has a cross-sectional diameter about the same with one of the spout 101 on the faucet 10. When the faucet 10 is used, a washed object only can be drenched to a small area and thus has to be moved constantly to clean the object allover during washing. Therefore, the faucet 10 is inconvenient and can not make most of water in use.

Although another conventional faucet combining an aerator is developed to filtrate water and create foam in water spout to save more water, problem about limited small washing area still exists.

### SUMMARY OF THE INVENTION

A main objective of the present invention is to provide an adjustable water-dispersing device for a faucet that is selectively switched to have a narrow spouting status or a wide spouting status to facilitate and efficiently improve the washing.

Another main objective of the present invention is to provide an adjustable water-dispersing device that enables to operate in the wide spouting status to avoid wasting water and to significantly save more water.

Still another main objective of the present invention is to provide an adjustable water-dispersing device that can be easily disassembled for cleaning and changing elements when the device is jammed or damaged.

To achieve the foregoing objective, the adjustable water-dispersing device comprises:

a housing having a channel, a valve chamber and a water chamber defined in the housing in longitudinal sequence to communicate with each other, wherein the valve chamber transversally extends to form a passage and an opening at two ends of the valve chamber, a first draining hole communicates the valve chamber and the water chamber, and a second draining hole communicates the passage and the water chamber;

a valve shaft movably received inside the valve chamber and having two ends, a controlling rod formed at one end of the valve shaft to extend out of the passage of the valve chamber, a neck defined between the two ends, a sealing ring mounted on another end of the valve shaft to operationally seal the passage;

a plug hermetically engaged the opening of the valve chamber;

a resilient element clamped between the valve shaft and the plug;

a pivotal bracket attached to an outer periphery of the housing below the passage;

a handle pivotally attached to both the pivotal bracket and the controlling rod of the valve shaft; and

a mouth cap received inside the water chamber of the housing and having a hollow insertion formed at a center of the mouth cap to align with the first draining hole, an outer area surrounding the hollow insertion and communicating with the second draining hole, and multiple spouting holes defined in a bottom of the outer area the mouth cap.

By having the above mentioned structure, the handle is pushed to drive the valve shaft to allow water flowing through only first draining hole or both draining holes to switch between a wide spouting form and a narrow spouting form.

Further benefits and advantages of the present invention will become apparent after a careful reading of the detailed description with appropriate reference to the accompanying drawings.

### BRIEF DESCRIPTION OF THE DRAWINGS

FIG. 1 is a side view of a conventional faucet in accordance with the prior art;

FIG. 2 is a perspective view of an adjustable water-dispersing device in accordance with the present invention, wherein the adjustable water-dispersing device is mounted on a faucet;

FIG. 3 is an exploded perspective view of the adjustable water-dispersing device in FIG. 2;

FIG. 4 is a perspective view of the adjustable water-dispersing device, wherein the adjustable water-dispersing device is assembled;

FIG. 5 is a partially cross-sectional side view of the adjustable water-dispersing device in FIG. 4;

FIG. 6 is an operational cross-sectional side view of the adjustable water-dispersing device that is in a narrow spouting status; and

FIG. 7 is an operational cross-sectional side view of the adjustable water-dispersing device that is in a wide spouting status.

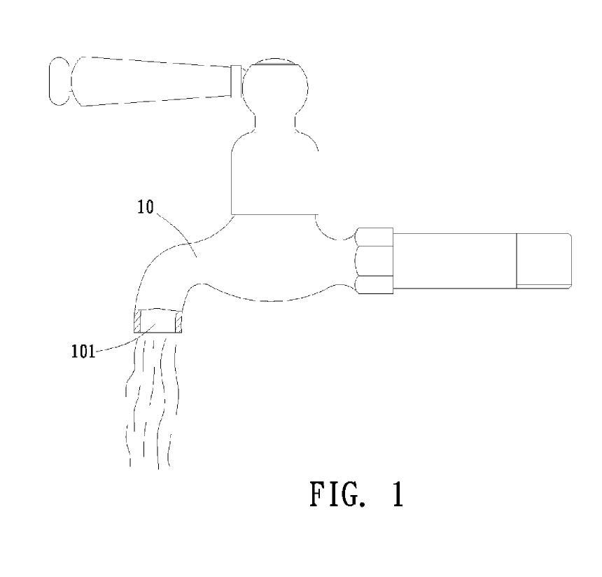

### DETAILED DESCRIPTION OF THE PREFERRED EMBODIMENT

An adjustable water-dispersing device in accordance with the present invention comprises a housing, a valve shaft, a plug, a resilient element, a pivotal bracket, a handle, a mouth cap and an aerator. Wherein, the housing has a channel, a valve chamber and a water chamber longitudinally defined therein and communicated with each other in sequence. A first draining hole and a second draining hole extend between the valve chamber and the water chamber. The valve shaft is movably received inside the valve chamber and engages the plug at one end. The resilient element is clamped between the valve shaft and the plug and to provide a restitution force to the valve shaft. The pivotal bracket is attached on an outer periphery of the housing and the handle is pivotally mounted on both the pivotal bracket and the valve shaft to drive the valve shaft. The mouth cap is received inside the water chamber, combines with the aerator at its center and has multiple spraying holes defined in bottom edge. By having the configuration, the handle enables to move the valve shaft to easily switch the spouting types.

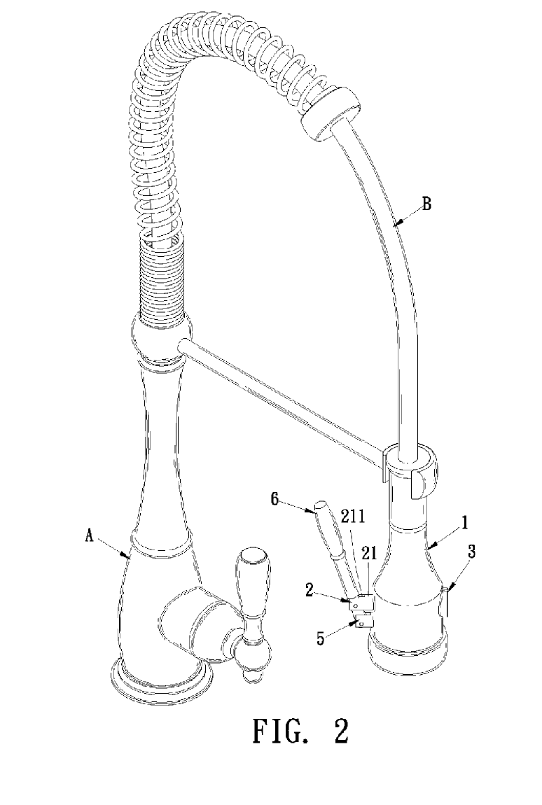

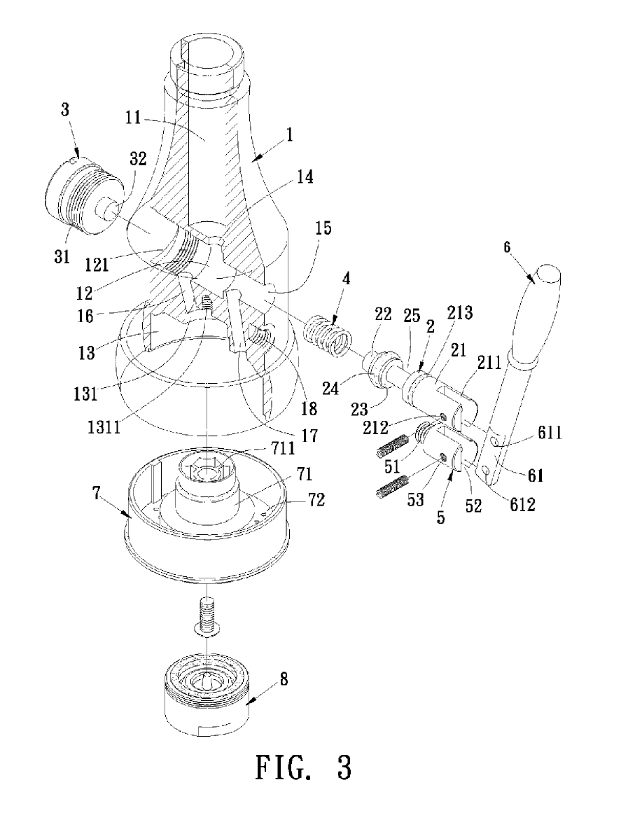

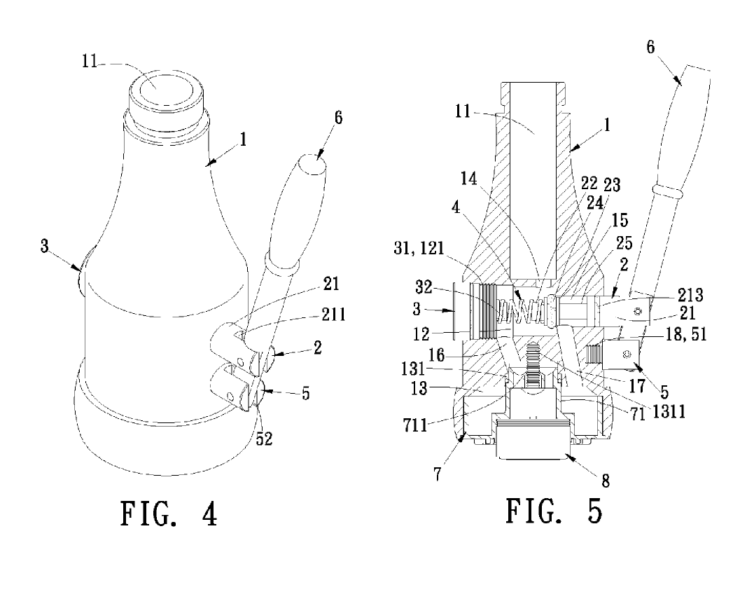

With reference to FIGS. 2 to 5, a preferred embodiment of the adjustable water-dispersing device is attached to an extension tube B extended from a faucet A and comprises a housing 1, a valve shaft 2, a plug 3, a resilient 4, a pivotal bracket 5, a handle 6, a mouth cap 7 and an aerator 8.

The housing 1 is horn-shaped and has a wide end, a tapered end, a longitudinal channel 111 defined in the tapered end, a valve chamber 12 transversally defined in a middle of the housing 1 and a water chamber 13 defined in the wide end. The longitudinally channel 111 has a bottom and communicates with the valve chamber 12 via an inlet hole 14 defined in the bottom. The valve chamber 12 transversally extends in the housing 1 and thus performs two opposite openings on periphery of the housing 1. An inner thread 121 is defined in one opening and a passage 15 is defines in the other opening of the valve chamber 12. The water chamber 13 has a top and a recess 131 with an engaging hole 1311 defined in the top. A first draining hole 16 communicates the valve chamber 12 and the recess 131 and a second draining hole 17 communicates the passage 15 and the water chamber 13. Moreover, a threaded recess 18 is defined on the periphery of the housing 1 below the passage 15.

The valve shaft 2 has two ends, a neck 25 defined between the two ends, a controlling shaft 21 with a slit 211 formed at one end, and a rim 23 formed at the other end. The controlling shaft 21 further two threaded holes 212 defined in two sidewalls of the slit 211 respectively to align with each other and a gasket 213 mounted on the valve shaft 2 near the neck 25. The rim 23 has a sealing ring 24 mounted thereon and has a first positioning stub 22 formed at edge of the corresponding end.

The plug 3 has an outer thread 31 to correspondingly engage the inner thread 121 in the valve chamber 12. An inner face of the plug 3 further has a second positioning stub 32 formed thereon. The resilient element 4 is preferred a spring.

The pivotal bracket 5 also has a slit 52 defined in one end and a threaded rod 51 formed at the other end to correspondingly engage the threaded recess 18 on the housing 1. Two threaded holes 53 are defined in two sidewalls of the slit 52 respectively to align with each other.

The handle 6 has a flat pivoting end 61 with two through holes 611, 612.

The mouth cap 7 is round-shaped and has a hollow insertion 71 formed at its center and constructed by a central hole surrounded by multiple radial plates. Particularly, the insertion 71 further has an upper post 711 to correspondingly engage the recess 131 in the housing 1. The mouth cap 7 further has multiple spouting holes 72 defined therein around the insertion 71. The aerator 8 is attached under the mouth cap 7 to align with the insertion 71.

When the adjustable water-dispersing device is assembled, as shown in FIG. 5, the valve shaft 2 is received inside the valve chamber 2 and extends out of the passage 15 at the controlling shaft 21. The gasket 213 snugly contacts inner wall of the passage 15 to keep the housing 1 hermetical. The plug 3 combines with the housing 1 by engaging the outer thread 31 with the inner thread 121 in the opening of the valve shaft 12. The resilient element 4 is clamped between the valve shaft 2 and the plug 3 and positioned by the positioning stubs 22, 32. In normal status, the sealing ring 23 on the valve shaft 2 abuts a joint of the passage 15 and the valve chamber 12 to enclose water inside the valve chamber 12. The pivotal bracket 5 mounted on the housing 1 by screwing the threaded rod 51 into the threaded recess 18 on the housing 1. The handle 6 has a flat pivoting end 61 received inside both slits 211, 52 of the valve shaft 2 and the pivotal bracket 5 and pivotally secured by penetrating threaded bolts into the threaded holes 212, 51 and the through holes 611, 612. The mouth cap 7 is received into the water chamber 13 of the housing 1 to engage the upper post 711 on the insertion 71 the recess 131 of the water chamber 13 by screwing a bolt into the engaging hole 1311 on the top of water chamber 13 via the central hole. Moreover, the aerator 8 attaches to the bottom of the mouth cap 7 to align with the insertion 71. Wherein, the first draining hole 16 aligns with the upper post 711 to achieve an inner path for narrow spouting form and the second draining hole 17 aligns with the outside of the insertion to achieve an outer path for wide spouting form.

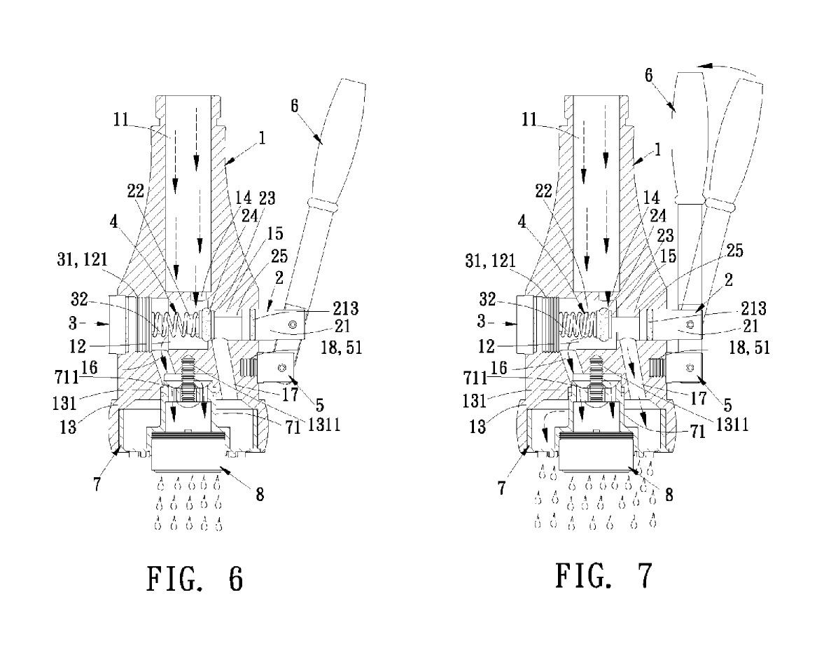

With reference to FIG. 6, when the adjustable water-dispersing device is in narrow spouting form, the water from the faucet A flows into the longitudinal channel 11 via the inlet hole 14 and the valve chamber 12. Because the passage 15 (i.e. the outer path) is blocked by the sealing ring 24 on the rim 23, water only drains out from the aerator 8 and the insertion 71 of the mouth cap 7 via the first draining hole 16.

As shown in FIG. 7, when the adjustable water-dispersing device is in the wide spouting form, the handle 6 is pushed toward the housing 1 to move the valve shaft 2 to detach the sealing ring 24 from the joint of the valve chamber 12 and the passage 15. Therefore, some water flows into the passage 15 via the second draining hole 17 and drains out of the mouth cap 7 via the multiple spouting holes 72. At the same time, other water still drains out through the inner path. By running water through both inner path and outer path, the wide spouting form is achieved.

According to above description, the adjustable water-dispersing device in the present invention has the following advantages:

1. The Switch between the wide and narrow spouting forms is achieved by simply pushing the handle. Therefore, an object can be washed conveniently and efficiently corresponding to its size.

2. When the adjustable water-dispersing device performs the wide spouting form, the object needs not to be moved constantly for washing so that more water can be saved.

3. The elements of the adjustable water-dispersing device enable to be detached for clean or repair conveniently when the device is jammed or damaged.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. An adjustable water-dispersing device for a faucet, which comprising:
a housing having a channel, a valve chamber and a water chamber defined in the housing in longitudinal sequence to communicate with each other, wherein the valve chamber transversally extends to form a passage and an opening at two ends of the valve chamber, a first draining hole communicates the valve chamber and the water chamber, and a second draining hole communicates the passage and the water chamber;
a valve shaft movably received inside the valve chamber and having two ends, a controlling rod formed at one end of the valve shaft to extend out of the passage of the valve chamber, a neck defined between the two ends, a sealing ring mounted on another end of the valve shaft to operationally seal the passage;
a plug hermetically engaged the opening of the valve chamber;
a resilient element clamped between the valve shaft and the plug;
a pivotal bracket attached to an outer periphery of the housing below the passage;
a handle pivotally attached to both the pivotal bracket and the controlling rod of the valve shaft; and
a mouth cap received inside the water chamber of the housing and having a hollow insertion formed at a center of the mouth cap to align with the first draining hole, an outer area surrounding the hollow insertion and communicating with the second draining hole, and multiple spouting holes defined in a bottom of the outer area the mouth cap.

2. The adjustable water-dispersing device as claimed in claim 1, wherein the opening has an inner thread and the plug has an outer thread corresponding the inner thread of the opening.

3. The adjustable water-dispersing device as claimed in claim 1, wherein the water chamber has a top and a recess defined in the top to engage the hollow insertion on the mouth cap.

4. The adjustable water-dispersing device as claimed in claim 1, wherein the housing has a threaded recess;
the pivotal bracket has a threaded rod to correspondingly engage the threaded recess of the housing.

5. The adjustable water-dispersing device as claimed in claim 1, wherein the valve shaft further comprises:
a slit defined in the controlling rod;
a gasket mounted on the controlling rod near the neck;
two threaded holes respectively defined in two sidewalls of the slit;
a rim formed on the end with the sealing ring opposite to the controlling rod and combined with the sealing ring thereon; and
a first positioning stub formed at an edge near the rim.

6. The adjustable water-dispersing device as claimed in claim 5, wherein the plug further has a second positioning stub formed at an edge of the plug.

7. The adjustable water-dispersing device as claimed in claim 1, wherein the resilient element is a spring.

8. The adjustable water-dispersing device as claimed in claim 1, wherein the pivotal bracket is performed by a slit and two threaded holes defined in two sidewalls of the silt.

9. The adjustable water-dispersing device as claimed in claim 1, wherein the handle has a pivoting end with two through holes thereon.

10. The adjustable water-dispersing device as claimed in claim 1, wherein the pivoting end is flat.

11. The adjustable water-dispersing device as claimed in claim 1, wherein the hollow insertion of the mouth cap further has an upper post detachably combined with the recess and composed of a central hole and multiple radial plates surrounding the central hole.

12. The adjustable water-dispersing device as claimed in claim 1, wherein the mouth cap further has an aerator attached under the hollow insertion.
